(19) United States
(12) Patent Application Publication
(10) Pub. No.: US 2003/0001545 A1
(43) Pub. Date: Jan. 2, 2003

(54) Method for estimating the position of the claw pole rotor of a claw pole machine

(76) Inventors: Gerhard Koelle, Wiernsheim (DE); Kurt Reutlinger, Stuttgart (DE); Beqir Pushkolli, Ludwigsburg (DE)

Correspondence Address: Striker Striker & Stenby, 103 East Neck Road, Huntington, NY, 11743, US

(21) Appl. No.: 10/089,052

(22) PCT Filed: Jun. 27, 2001
(86) PCT No.: PCT/DE01/02368

(30) Foreign Application Priority Data
Jul. 28, 2000 (DE) 100 36 869.7

(51) Int. Cl. H02H 7/06; H02P 9/00; H02P 11/00

(52) U.S. Cl. 322/37

(57) ABSTRACT

The invention relates to a method for determining the position of a rotating component of a claw pole machine (1), which is operated in the R-S-T-system and whose regulation requires the transformation of the stator values from the R-S-T-system into the d, q-system and vice versa. The claw pole machine (1) as an overall system (15) is divided into a non-detectable subsystem (18) and a detectable subsystem (19), which contains a filter element (20). The filter element (20) contained in the detectable subsystem (19, 29) supplies the output values (17).

### TECHNICAL FIELD

Rotary current generators are used to supply electrical energy to the electrical system of motor vehicles. Because claw pole generators are rugged in design and inexpensive to manufacture, using them in motor vehicles has become a common practice. These claw pole machines contain a laminated stator packet with a three-phase winding. The rotary field generates a three-color current in the winding. The battery of a motor vehicle requires a direct current for charging, which is why the vehicle electrical system is a direct-current system and the rotary current generator is connected to the vehicle electrical system via a rectifier bridge.

### PRIOR ART

Electrical power in motor vehicles is generated by claw pole generators, which are connected to the direct-current electrical system of a motor vehicle via a passive diode rectifier bridge. As a rule, the rotary current generators are dimensioned so that the required electrical power can be generated even when the vehicle's internal combustion engine is idling. Instead of passive diode rectifier bridges, pulse inverters can also be used, which permit electrical power to be output by a rotary current generator even at speeds in the lower idling range of an internal combustion engine.

Claw pole machines are regulated by regulators or regulating structures, which require the transformation of currents and voltages of the stator windings of the electric machine from the R-S-T three-phase system into the d, q-system and the inverse transformation of the current and voltage values from the d, q-system back into the R-S-T three-phase system. In order to be able to definitely execute the transformation by means of a matrix, it is necessary to know the angular position of the magnet wheel in the electric machine so that the transformation and the subsequent inverse transformation are definite and no multiple associations can occur. The magnet wheel position is usually determined by a sensor specifically provided for this, the magnet wheel detector.

In addition to the use of a magnet wheel position detector, the magnet wheel position of a claw pole generator can be detected by a status detector, where a reduced status detector can also easily be used. The status detectors are respectively designed so that they reconstruct the system status after a change in the status value. However, using a status detector to detect and correct occurrences of stochastic interference in a controlled system of a regulating structure is either impossible or can only be achieved to an insufficient degree.

### DEPICTION OF THE INVENTION

The method proposed according to the invention makes it possible on the one hand to avoid the use of a magnet wheel position detector as an additional component on a claw pole generator so that the costs involved with its use for the measurement of the magnet wheel angular position can be eliminated.

On the other hand, through the use of a filter element, preferably a Kalman-Bucy filter element, now a detection of stochastic influences going into a control system can also be executed, which represents progress because with status detectors, it is only possible for there to be a delayed reconstruction of the system status after the change in a system status value. With the status detectors used up to this point, a transformation matrix is determined for the transformation from the d, q-system into the R-S-T-system and vice versa by means of a pole preset. Consequently, the precision of the transformation and inverse transformation depends on the precision of the pole preset. With the filter element used, however, the precision of the transformation results from the optimization of a required efficiency rating. A significantly increased precision can be achieved through the use of this efficiency rating in determining the transformation from the d, q-system into the R-S-T-system of the electric machine.

### DRAWINGS

The invention will be explained in detail below in conjunction with the drawings.

FIG. 1 is a schematic depiction of a claw pole generator with a rotor winding and a stator winding,

FIG. 2 is an equivalent depiction of the claw pole generator in the status area,

FIG. 3 shows the division of the system of the claw pole generator into a detectable subsystem and a non-detectable subsystem, and

FIG. 4 is a more detailed depiction of the detectable subsystem and the Kalman-Bucy filter.

FIG. 5 shows an alternative potential embodiment of the detectable subsystem as a reduced status detector, and

FIG. 6 shows a measurement circuit for determining the rotor position of the claw pole generator when it is at rest.

### EMBODIMENTS

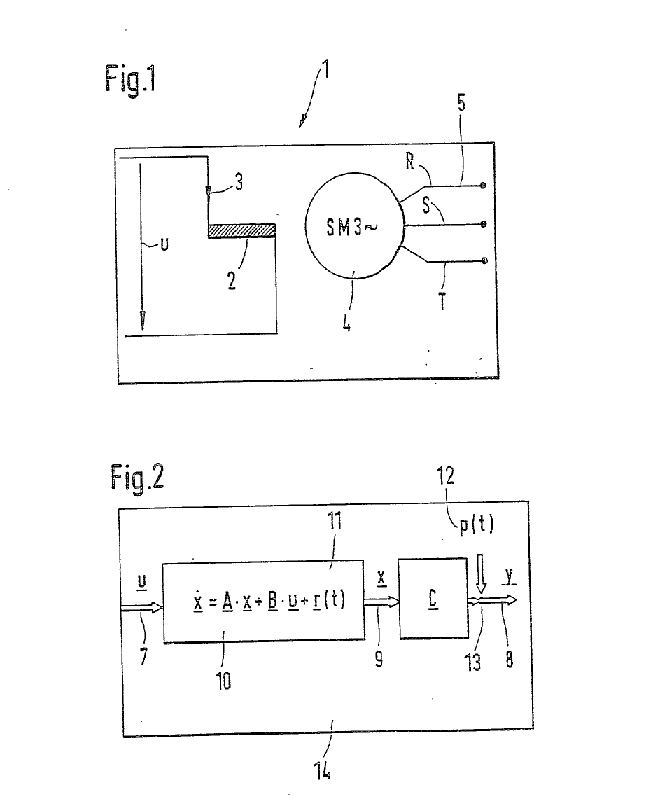

FIG. 1 schematically depicts a claw pole generator with an exciter winding and a stator winding.

FIG. 1 shows the exciter winding 2, which an excitation current i_{F}, reference numeral 3, flows through when a voltage is applied to its connecting terminals. The electric machine 1, essentially comprised of the exciter winding 2 and the stator winding 4, is embodied as a rotary current machine and is operated in the R-S-T-system. Three phase strands are shown leading from the stator winding 4 in the depiction in FIG. 1 and correspond to the phases R, S, and T.

FIG. 2 reproduces the equivalent depiction of the electric machine 1 according to FIG. 1 in the status area.

In the status area 14, the electric machine 1 is depicted in an equivalent form, essentially characterized by the derivation 10 of the status vector x. The input value is the input vector u. The input vector u is comprised of the transformed stator voltages u_{d}, u_{q}, which have been transformed from the R-S-T-system into the d, q-system, and of the rotor voltage in the electric machine 1. The derivation of the status vector 9 is given by the equation:

x=A·x+B·u+r(t)

where r(t) is the system noise, x is the status vector, which includes the exciter current i_{F} and the transformed stator currents i_{d}, i_{q}, which are likewise transferred from the R-S-T-system into the d, q-system. For the most part, the torque that can be generated by the electric machine 1 is determined by the stator current portion i_{q}. The status vector 9, combined with a constant C, is sent to a summation point 13, to which also a measurement noise ρ (t) is also sent. By taking into account the measurement noise ρ (t), characterized by the reference numeral 12, the output voltage vector y is produced, labeled with the reference numeral 8.

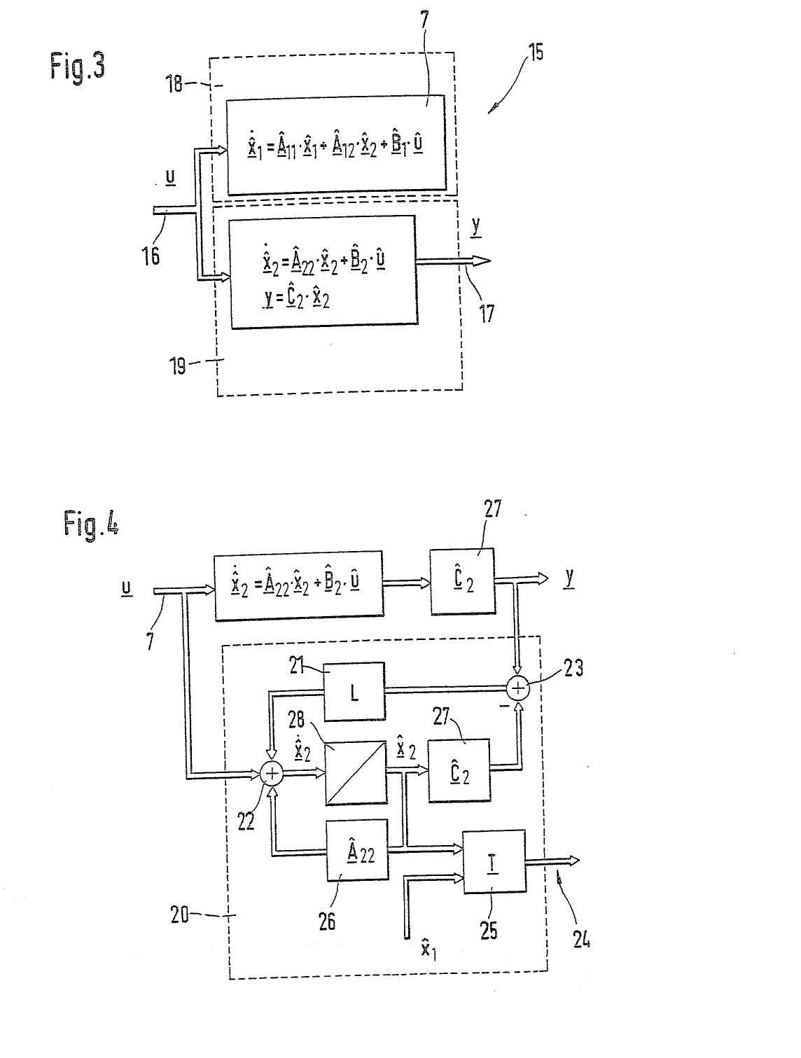

FIG. 3 depicts the overall system of the electric machine in subsystems.

Starting with the overall system 15, the electric machine 1 can be divided into a detectable subsystem 19 and a non-detectable subsystem 18. In the detectable subsystem 19, the status values can be estimated through the installation of a Kalman-Bucy filter element 20 (see FIG. 4). The status values of the non-detectable subsystem 18, though, are calculated. For the calculation of the status values of this subsystem, the status values obtained by means of the filter element 20 are taken from the detectable subsystem 19; however, these could also be determined by means of a status detector—provided that it is considered acceptable to disregard stochastic influences in the control system. The calculated and estimated status values are inverse transformed through combination with the transformation matrix, which produces an estimated magnet wheel angular position that corresponds to the actual position of the magnet wheel.

FIG. 4 gives a detailed depiction of the detectable subsystem of an electric machine.

Outside the dashed border of the filter element 20, the depiction in FIG. 4 essentially corresponds to the depiction in the status area 14 according to FIG. 2. The input value of the status vector x₂ is the input vector u, which is comprised of two parts, which after passing through a constant C₂, labeled by the reference numeral 27, are transformed into an output vector y. At a summation point 22 inside the filter element 20, the input values of the input vector 7 u are sent to an integration component 28, from which they are supplied to a representative component that corresponds to the constant C₂, from which they are forwarded to another summation point 23. The component 27 sends its output signals, combined with a negative sign, to the summation point 23. From this summation point 23, the supply line branches to an L-matrix component 21, in which if a status detector were used, the matrix would be determined by means of a magnet wheel position preset. When the filter element 20 is embodied as a Kalman-Bucy filter element, the matrix L, reference numeral 21, is determined based on the optimization of a quadratic efficiency rating.

The general quadratic efficiency criterion is yielded by the following relationship:

$$J ( u ) = {\int }_{{t}_{0}}^{{t}_{f}} [ {x}^{T} ( t ) Q x ( t ) + {u}^{T} ( t ) R u ( t ) ] ⅆ t$$

where

Q=weighting matrix

t₀=starting time

t_{f}=finishing time

for multiple systems in which the status values themselves represent physical values.

The output value of the matrix component 21 is sent to the summation point 22 mentioned above, which likewise receives a signal from the component 26. In addition to the previously-mentioned constant-processing components 26, 27, the integration component 28, and the component 21 that constitutes the L-Matrix, the Kalman-Bucy filter element 20 is also associated with an additional component 25 in which a transformation matrix 25 is stored. At an estimation value output 24, the transformation matrix 25 of the filter element 20 forms the basis for the estimated output values of the detectable subsystem 19 of the overall system 15 of the electric machine 1, which can be based on a calculation of the status values of the non-detectable subsystem 18 (see FIG. 3) of the overall system 15 of the electric machine 1.

Both the status values estimated by means of the Kalman-Bucy filter element 20 in the detectable subsystem 19 and the status values of the non-detectable subsystem 19 of the overall system 15, which are calculated based on the estimated status values, are once again combined with the transformation matrix so that the values in the R-S-T-system can be inverse transformed into the R-S-T-system values of the overall system 15 of the electric machine. These values then include an estimated magnet wheel angular value, which essentially corresponds to or is identical to the actually existing magnet wheel angular value.

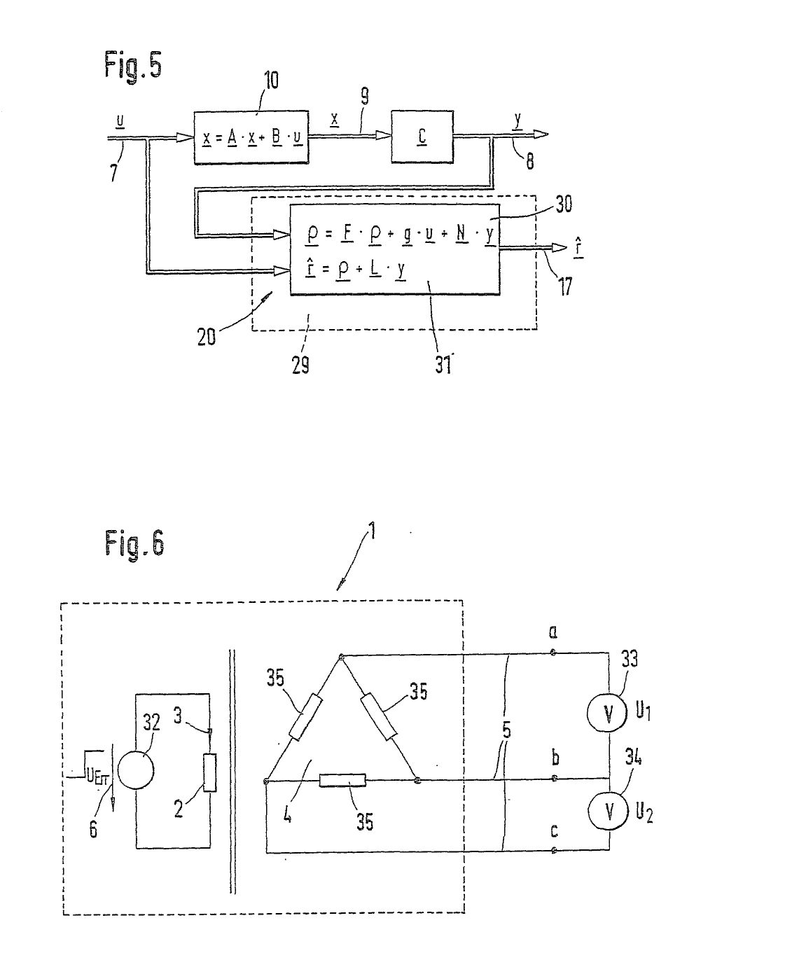

FIG. 5 shows an alternative potential embodiment of the detectable subsystem as a reduced status detector.

The status value sector has the following appearance:

$$\underline{x} = ( \begin{matrix}\underline{r} \\ \underline{y}\end{matrix} )$$

where r represents the vector of the corollary status variables, in the current instance of the angular frequency ω and the magnet wheel position angle.

$$( \begin{matrix}\underline{\dot{r}} \\ \\ \underline{\dot{y}}\end{matrix} ) = ( \begin{matrix}\underline{{A}_{11}} & \underline{{A}_{12}} \\ & \\ \underline{{A}_{21}} & \underline{{A}_{22}}\end{matrix} ) \cdot ( \begin{matrix}\underline{r} \\ \\ \underline{y}\end{matrix} ) + ( \begin{matrix}\underline{{B}_{1}} \\ \\ \underline{{B}_{2}}\end{matrix} ) \cdot ( \begin{matrix} \\ \underline{u} \\ \end{matrix} )$$

From this, the following status equations can be inferred:

ρ=(A₁₁−L·A₂₁)·ρ+(B₁−L·B₂)·u+[(A₁₁−L·A₂₁)·L+A₁₂−L·A₂₂]·y

\hat{r}=ρ+L·y

Whereas in the configuration according to FIG. 4, all of the status values are estimated by means of the filter element 20, in those cases in which q of n values are to be measured, only (n-q) status values need to be estimated. A detector of this kind is a detector of a reduced order and must consequently be viewed as a reduced detector 29, which is shown in the depiction according to FIG. 5.

FIG. 6 shows a measurement circuit for determining the rotor position when it is at rest.

The exciter circuit 2, 32 has a chronologically variable voltage source 32 disposed in it, which can produce a chronologically variable exciter current i_{F} 3 in the exciter winding 2. In this case, a magnetic flux is built up, which originates from the exciter side 2, 32 of the claw pole machine 1. For a chronologically variable exciter voltage u_{Eπ}6, the stator voltage of the stator winding 4 is measured in the strands 5 by two voltmeters 33, 34. The phase voltages give information as to the position of the rotor of the claw pole machine because they are a function of the magnet wheel position angle.

This provides input information regarding the rotor position for the status detector 19, 29 according to FIGS. 4 and 5.

With the method proposed according to the invention, it is possible to divide an electric synchronous machine, for example a rotary current generator, which is not completely detectable, so that the overall system of the electric machine can be divided into a detectable subsystem and a non-detectable subsystem. Through the use of a Kalman-Bucy filter element 20 in the detectable subsystem 19, status values can be estimated with a high degree of forecast precision, which permit a calculation of status values in the intrinsically non-detectable subsystem.

| | |
|---|---|
| 1 | electric machine |
| 2 | exciter winding |
| 3 | exciter current i_{F} |
| 4 | stator winding |
| 5 | phase strands |
| 6 | exciter voltage |
| 7 | input vector u |
| 8 | output vector y comprised of transformed stator currents and i_{F} |
| 9 | status vector x |
| 10 | derivation of status vector x |
| 11 | system noise r (t) |
| 12 | measurement noise ρ (t) |
| 13 | summation point |
| 14 | status area |
| 15 | overall system |
| 16 | input values |
| 17 | output values |
| 18 | non-detectable subsystem |
| 19 | detectable subsystem |
| 20 | filter element |
| 21 | L-matrix |
| 22 | summation point |
| 23 | summation point |
| 24 | estimation value output |
| 25 | T-matrix |
| 26 | constant A |
| 27 | constant C |
| 28 | integration component |
| 29 | reduced detector |
| 30 | status equation |
| 31 | status equation |
| 32 | chronologically variable voltage source |
| 33 | voltmeter |
| 34 | voltmeter |
| 35 | coils |

1. A method for determining the position of a rotating component of a claw pole generator (1), which is operated in the R-S-T-system and whose regulation requires the transformation of the stator values from the R-S-T-system into the d, q-system and vice versa, characterized in that the claw pole generator (1) as an overall system (15) is divided into a non-detectable subsystem (18) and a detectable subsystem (19), which contains a filter element (20) and supplies output values (17).

2. The method according to claim 1, characterized in that the detectable subsystem (19) contains a Kalman-Bucy filter element (20), which estimates the status values of the detectable subsystem (19).

3. The method according to claim 1, characterized in that the detectable subsystem (19) contains a status detector, which recalculates status values of the detectable subsystem (19) after a status change.

4. The method according to claim 1, characterized in that the electric machine (1) is divided by a transformation matrix T into a non-detectable subsystem (18) and a detectable subsystem (19).

5. The method according to claim 2, characterized in that an L-matrix (21) in the filter element (20) of the detectable subsystem (19) is determined based on the optimization of a quadratic efficiency rating
$$J ( u ) = {\int }_{{t}_{0}}^{{t}_{f}} [ {x}^{T} ( t ) Q x ( t ) + {u}^{T} ( t ) R u ( t ) ] ⅆ t$$

6. The method according to claim 2, characterized in that the status values (9) of the detectable subsystem (19) of the overall system (15) of the claw pole machine (1) are estimated by means of the filter element (20).

7. The method according to claim 2 or 3, characterized in that the status values of the non-detectable subsystem (18) are calculated based on the estimated and calculated status values of the detectable subsystem (19).

8. The method according to claim 6 or 7, characterized in that the estimated status values and the calculated status values of the subsystems (18, 19) are inverse transformed through combination with a transformation matrix T.

9. The method according to claim 6, characterized in that the status values (9) include the transformed stator currents of the d, q-system, the angular frequency ω, and the magnet wheel angle of the rotor of the claw pole machine (1).

10. The method according to claim 1, characterized in that in order to determine the rotor starting position, a chronologically variable voltage source (32) is disposed in the exciter circuit (2, 32) of the claw pole machine (1), and a measurement (33, 34) of the phase voltages (5) of the stator winding (4) is executed.
